(19) United States
(12) Patent Application Publication
(10) Pub. No.: US 2024/0051171 A1
(43) Pub. Date: Feb. 15, 2024

(54) ROBOT SYSTEM, METHOD, AND COMPUTER PROGRAM FOR PERFORMING SCRAPING PROCESS

(71) Applicant: Fanuc Corporation, Minamitsuru-gun, Yamanashi (JP)

(72) Inventor: Tadanori Suzuki, Minamitsuru-gun, Yamanashi (JP)

(73) Assignee: Fanuc Corporation, Minamitsuru-gun, Yamanashi (JP)

(21) Appl. No.: 18/266,863

(22) PCT Filed: Dec. 21, 2021
(86) PCT No.: PCT/JP2021/047417

§ 371 Date: Jun. 13, 2023

(30) Foreign Application Priority Data
Dec. 28, 2020 (JP) 2020-219442

(51) Int. Cl. B26D 5/00; B26D 3/08; B25J 11/00

(52) U.S. Cl. CPC B26D 5/005; B26D 3/08; B25J 11/005

(57) ABSTRACT

A robot system includes a robot configured to move a scraper configured to scrape the surface, and a control device configured to control the robot. The control device is configured to execute the scraping process by moving the scraper in a direction along the surface while pressing the scraper against the surface by the robot, and during the execution of the scraping process, repeatedly increase and decrease a depth of scraping the surface by controlling a position of the robot so as to repeatedly increase and decrease a pressing force by which the robot presses the scraper against the surface.

### CROSS REFERENCE TO RELATED APPLICATIONS

This is the U.S. National Phase application of PCT/JP2021/047417, filed Dec. 21, 2021, which claims priority to Japanese Patent Application No. 2020-219442, filed Dec. 28, 2020, the disclosures of each of these applications being incorporated herein by reference in their entireties for all purposes.

### FIELD OF THE INVENTION

The present disclosure relates to a robot system, a method, and a computer program for performing a scraping process.

### BACKGROUND OF THE INVENTION

There is a known robot that performs a scraping process (e.g., Patent Document 1).

### PATENT LITERATURE

Patent Document 1: JP 2004-042164 A

### SUMMARY OF THE INVENTION

In the related art, a task of forming a plurality of unevennesses aligned in one direction on a surface of a workpiece by a scraping process is performed manually by an expert.

In one aspect of the present disclosure, a robot system configured to perform a scraping process to scrape and flatten a surface of a workpiece, includes a robot configured to move a scraper configured to scrape the surface, and a control device configured to control the robot, wherein the control device is configured to execute the scraping process by moving the scraper in a direction along the surface while pressing the scraper against the surface by the robot, and during the execution of the scraping process, repeatedly increase and decrease a depth of scraping the surface by controlling a position of the robot so as to repeatedly increase and decrease a pressing force by which the robot presses the scraper against the surface.

In another aspect of the present disclosure, a method of a scraping process to scrape and flatten a surface of a workpiece using a robot configured to move a scraper configured to scrape the surface of the workpiece, the method includes executing the scraping process by moving the scraper in a direction along the surface while pressing the scraper against the surface by the robot, and repeatedly increasing and decreasing, during the execution of the scraping process, a depth of scraping the surface by controlling a position of the robot so as to repeatedly increase and decrease a pressing force by which the robot presses the scraper against the surface.

According to the present disclosure, a recess with a plurality of valleys and crest portions aligned in one direction can be quickly formed by the operation of the robot. Thus, the cycle time of the scraping process can be reduced and a recess can be automatically formed with the same quality as the recess formed by an expert.

### BRIEF DESCRIPTION OF DRAWINGS

FIG. 1 is a schematic diagram of a robot system according to an embodiment.

FIG. 2 is a block diagram of the robot system illustrated in FIG. 1.

FIG. 3 is an enlarged view of a scraper as seen from arrow B in FIG. 1.

FIG. 4 illustrates a state where the scraper illustrated in FIG. 1 is pressed against a surface of a workpiece.

FIG. 5 illustrates an example of teaching points set with respect to a surface of a workpiece.

FIG. 6 is a diagram explaining a speed command as a position control command and a speed command as a force control command.

FIG. 7 illustrates a trajectory in which a scraper actually moves during the scraping process.

FIG. 8 illustrates time change characteristics of a pressing force in a force control according to one embodiment.

FIG. 9 schematically illustrates a recess formed by the scraping process.

FIG. 10 schematically illustrates a recess formed by the scraping process.

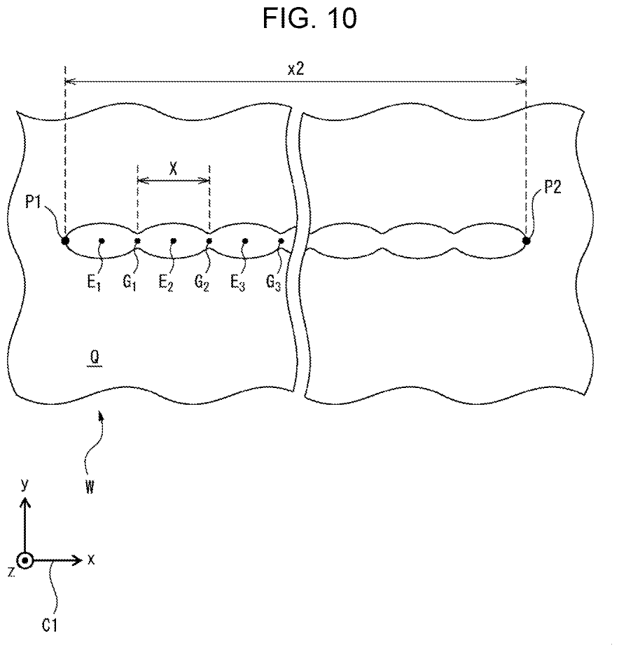

FIG. 11 schematically illustrates a state of a handle portion of the scraper during the scraping process.

FIG. 12 illustrates time change characteristics of a pressing force in a force control according to another embodiment.

FIG. 13 illustrates time change characteristics of a pressing force in a force control according to still another embodiment.

FIG. 14 illustrates time change characteristics of a pressing force in a force control according to still another embodiment.

FIG. 15 illustrates time change characteristics of a pressing force in a force control according to still another embodiment.

FIG. 16 illustrates an example of an operation flow of a scraping process method.

FIG. 17 illustrates an example of a flow of step S1 in FIG. 16.

FIG. 18 illustrates an example of a flow of step S2 in FIG. 16.

FIG. 19 illustrates time change characteristics of a pressing force in a force control executed in step S13 in FIG. 17.

FIG. 20 illustrates another example of a trajectory of the scraper in the scraping process.

FIG. 21 is another example of teaching points set with respect to a surface of a workpiece.

### DETAILED DESCRIPTION OF EMBODIMENTS OF THE INVENTION

Embodiments of the present disclosure will be described in detail below based on the drawings. Note that in the various embodiments described below, similar elements are denoted by the same signs, and overlapping descriptions are omitted. In the following description, the x-axis plus direction of a robot coordinate system C1 in the drawings may be referred to as rightward, the y-axis plus direction as forward, and the z-axis plus direction as upward.

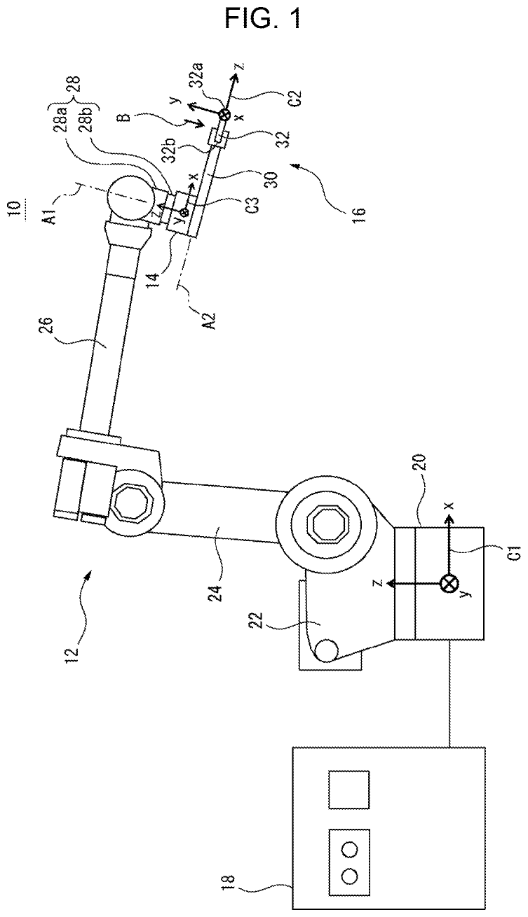

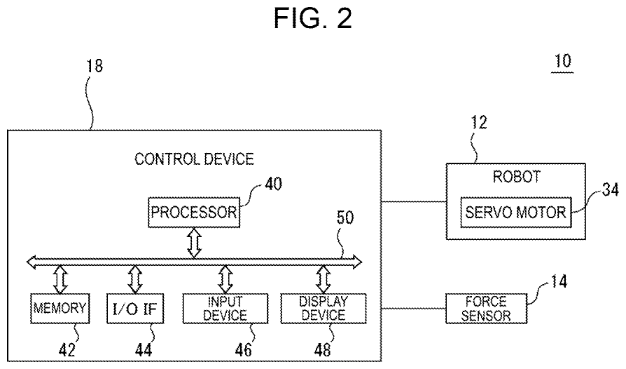

First, a robot system 10 according to one embodiment will be described with reference to FIGS. 1 and 2. The robot system 10 is a system that performs the scraping process to scrape and flatten a surface Q of a workpiece W. The scraping process is a process to scrape the surface Q of the workpiece such that fine unevenness formed on the surface Q of the workpiece W has a dimension in a thickness direction of the workpiece W falling within a predetermined range (e.g., on the order of μm). This fine unevenness functions as a so-called “oil retention” configured to store a lubricating oil on the surface Q used as a sliding surface.

The robot system 10 includes a robot 12, a force sensor 14, a scraper 16, and a control device 18. In the present embodiment, the robot 12 is a vertical articulated robot and includes a robot base 20, a turning body 22, a lower arm 24, an upper arm 26, and a wrist 28. The robot base 20 is fixed on the floor of the work cell. The turning body 22 is provided on the robot base 20 being turnable around the vertical axis.

The lower arm 24 is provided at the turning body 22 rotatably about the horizontal axis, and the upper arm 26 is rotatably provided at the tip of the lower arm 24. The wrist 28 includes a wrist base 28a provided rotatably at the tip of the upper arm 26 and a wrist flange 28b provided at the wrist base 28a being rotatable about a wrist axis A1.

Each component (the robot base 20, the turning body 22, the lower arm 24, the upper arm 26, the wrist 28) of the robot 12 is provided with a servo motor 34 (FIG. 2). These servo motors 34 rotate each movable element (the turning body 22, the lower arm 24, the upper arm 26, the wrist 28, the wrist flange 28b) of the robot 12 about the drive shaft in response to a command from the control device 18. As a result, the robot 12 can move and arrange the scraper 16 at any position and any orientation.

The force sensor 14 detects a pressing force F by which the robot 12 presses the scraper 16 against the surface Q of the workpiece W. For example, the force sensor 14 is a six-axis force sensor including a body having a cylindrical shape and a plurality of strain gauges provided at the body, and is interposed between the wrist flange 28b and the scraper 16. In the present embodiment, the force sensor 14 is arranged such that a center axis of the force sensor 14 coincides with the wrist axis A1.

The scraper 16 is fixed to the tip of the force sensor 14 and scrapes the surface of the workpiece W for the scraping process. Specifically, the scraper 16 includes a flexible handle portion 30 and a blade portion 32 fixed to the tip of the handle portion 30. The handle portion 30 includes a base end fixed to the tip of the force sensor 14 and is connected to the wrist flange 28b of the robot 12 via the force sensor 14.

The handle portion 30 extends linearly along an axis line A2 from the tip of the force sensor 14. The blade portion 32 is made of a metal material (e.g., steel) having a higher stiffness than the handle portion 30, and extends along the axis line A2 from a base end 32b to a tip 32a thereof. Note that the axis line A2 may be substantially orthogonal to the wrist axis A1.

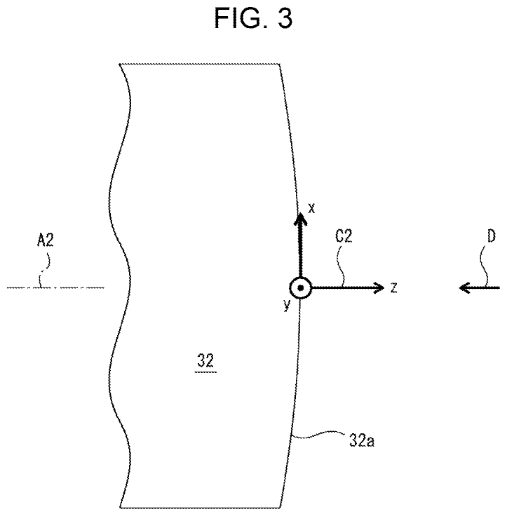

As illustrated in FIG. 3, the tip 32a of the blade portion 32 is curved to bulge outward from both ends of its width direction toward the center when viewed from the upper side (direction of arrow B in FIG. 1). The scraper 16 presses the tip 32a of the blade portion 32 thereof against the surface Q of the workpiece W and scrapes the surface Q with the tip 32a.

The control device 18 controls the operation of the robot 12. As illustrated in FIG. 2, the control device 18 is a computer including a processor 40, a memory 42, an I/O interface 44, an input device 46, and a display device 48. The processor 40 is communicatably connected to the memory 42, the I/O interface 44, the input device 46, and the display device 48 via a bus 50, and performs arithmetic processing for executing the scraping process while communicating with these components.

The memory 42 includes a RAM, a ROM, or the like, and temporarily or permanently stores various types of data used in the arithmetic processing executed by the processor 40 and various types of data generated during the arithmetic processing. The I/O interface 44 includes, for example, an Ethernet (trade name) port, a USB port, an optical fiber connector, or an HDMI (trade name) terminal, and performs wired or wireless data communication with an external device under a command from the processor 40. In the present embodiment, each of the servo motors 34 of the robot 12 and the force sensor 14 are communicably connected to the I/O interface 44.

The input device 46 includes a keyboard, a mouse, a touch panel, or the like, and allows the operator to input data. The display device 48 includes a liquid crystal display, an organic EL display, or the like, and visibly displays various types of data under a command from the processor 40. The input device 46 or the display device 48 may be integrally incorporated in a housing of the control device 18, or may be externally mounted at the housing of the control device 18 as a component separate from the housing.

As illustrated in FIG. 1, a robot coordinate system C1 is set for the robot 12. The robot coordinate system C1 is a coordinate system configured to control the operation of each movable element of the robot 12 and is fixed with respect to the robot base 20. In the present embodiment, the robot coordinate system C1 is set with respect to the robot 12 such that the origin of the robot coordinate system C1 is arranged at the center of the robot base 20 and the z-axis of the robot coordinate system C1 coincides with the turning axis of the turning body 22.

On the other hand, a tool coordinate system C2 is set for the scraper 16. The tool coordinate system C2 is a coordinate system that defines a position and an orientation of the scraper 16 (or wrist flange 28b) in the robot coordinate system C1. In the present embodiment, the tool coordinate system C2 is set with respect to the scraper 16 such that the origin of the tool coordinate system C2 (so-called TCP) is arranged at the center of the tip 32a of the blade portion 32 in a state in which the handle portion 30 is not bending and the z-axis of the tool coordinate system C2 is parallel to the axis line A2 (or a normal direction of the curved surface of the tip 32a at the center of the tip 32a).

When moving the scraper 16, the processor 40 of the control device 18 sets the tool coordinate system C2 in the robot coordinate system C1, and generates a command (position command, speed command, torque command, or the like) to each servo motor 34 of the robot 12 such that the scraper 16 is arranged at a position and an orientation represented by the set tool coordinate system C2. Thus, the processor 40 positions the scraper 16 in any position and any orientation in the robot coordinate system C1, thereby executing the scraping process.

On the other hand, a sensor coordinate system C3 is set for the force sensor 14. The sensor coordinate system C3 is a coordinate system that defines a direction of a force acting on the force sensor 14. In the present embodiment, the sensor coordinate system C3 is set with respect to the force sensor 14 such that the origin of the sensor coordinate system C3 is arranged at the center of the force sensor 14 and the z-axis of the sensor coordinate system C3 coincides with the wrist axis A1 (or the x-axis of the sensor coordinate system C3 is parallel to the z-axis of the tool coordinate system C2).

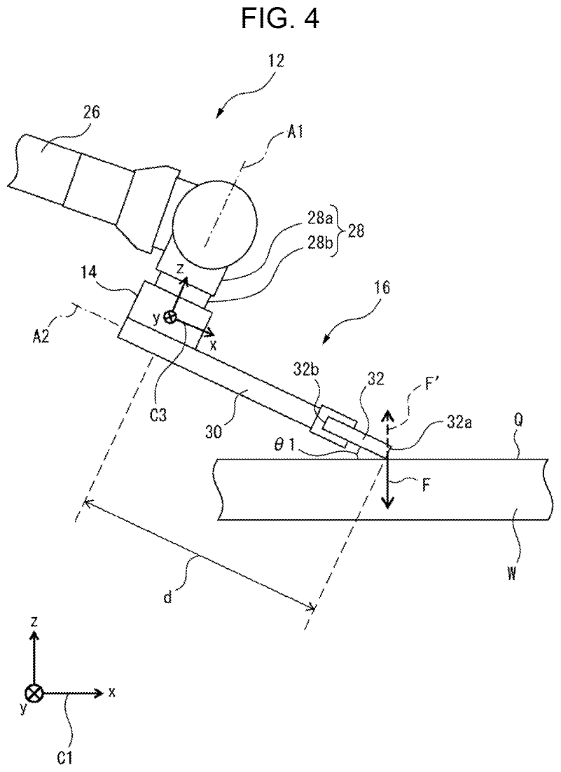

FIG. 4 illustrates a state where the robot 12 presses the tip 32a of the blade portion 32 of the scraper 16 against the surface Q of the workpiece W. When the robot 12 presses the tip 32a of the scraper 16 against the surface Q in a direction orthogonal to the surface Q with the pressing force F, the reaction force F′ of the pressing force F is applied from the surface Q to the force sensor 14 via the scraper 16.

Each of the strain gauges of the force sensor 14 transmit detection data corresponding to the force acting on the force sensor 14 at this time to the control device 18. Based on the detection data received from the force sensor 14 via the I/O interface 44, the processor 40 obtains forces fin the x-axis direction, the y-axis direction, and the z-axis direction of the sensor coordinate system C3, and torques τ around the x-axis direction, the y-axis direction, and the z-axis direction, acting on the force sensor 14 at this time. The processor 40 calculates the magnitude of the reaction force F′ acting on the tip 32a of the blade portion 32 in a direction orthogonal to the surface Q based on the forces f, the torques τ, and state data CD of the scraper 16 at this time.

The state data CD includes, for example, at least one of an angle θ1 between the axis line A2 and the surface Q, a distance d from the wrist axis A1 (or the origin of the sensor coordinate system C3) to the tip 32a of the blade portion 32, a position data indicating the position and the orientation of the tool coordinate system C2 (or the sensor coordinate system C3) in the robot coordinate system C1, and a bending data (e.g., a bending amount or an elastic modulus, of the handle portion 30) of the handle portion 30. In this way, the force sensor 14 detects the reaction force F′ as the pressing force F, and the control device 18 can determine the magnitude of the pressing force F (reaction force F′) based on the detection data of the force sensor 14.

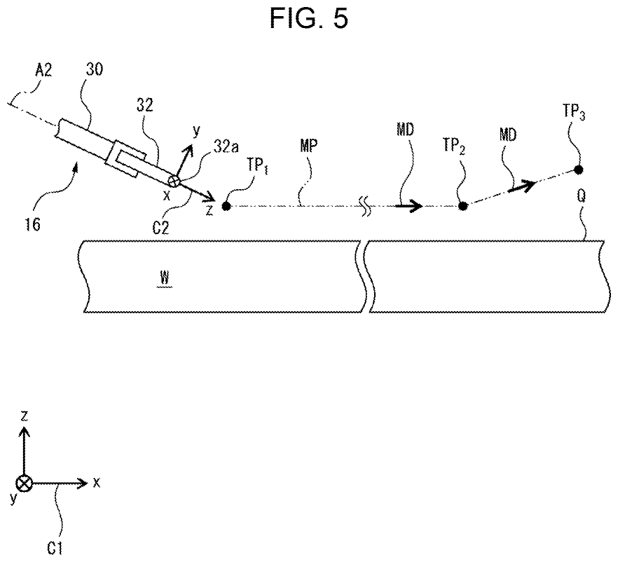

Next, the scraping process executed by the robot 12 will be described with reference to FIGS. 5 to 7. As illustrated in FIG. 5, a plurality of teaching points TP₁, TP₂ and TP₃ where the tip 32a (i.e., TCP) of the scraper 16 is to be positioned for executing the scraping process are set along the surface Q of the workpiece W positioned at known positions in the robot coordinate system C1.

In the present embodiment, the teaching point TP₂ is set at a position separated rightward from the teaching point TP₁, and the teaching point TP₃ is set at a position separated toward upper right of the teaching point TP₂. The positions of the teaching points TP₁ and TP₂ in the z-axis direction of the robot coordinate system C1 are substantially identical to each other. These teaching points TPₙ (n=1, 2, 3) are represented by coordinates in the robot coordinate system C1.

When performing the scraping process, the processor 40 starts a position control α and generates a position control command PCₙ to move the scraper 16 to a teaching point TPₙ by the robot 12. The processor 40 positions the scraper 16 in the order of teaching points TP₁→TP₂→TP₃, by operating each servo motor 34 of the robot 12 according to this position control command PCₙ. With this position control α, the processor 40 moves the scraper 16 (specifically, tip 32a) along a movement path MP defined by the plurality of teaching points TPₙ.

In the present embodiment, for ease of understanding, it is assumed that the surface Q of the workpiece W is substantially parallel to an x-y plane of the robot coordinate system C1, and a direction MD of a movement path MP is substantially parallel to an x-z plane of the robot coordinate system C1. A position control command PCₙ includes a speed command PC_{V_n} defining a speed V_{P_n} at which the scraper 16 (i.e., wrist flange 28b of the robot 12) is moved to the teaching point TPₙ.

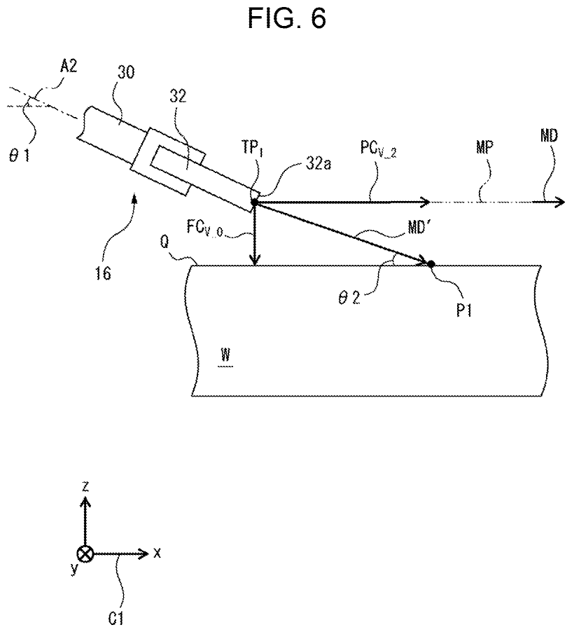

After starting the position control α, the processor 40 moves the scraper 16 to the teaching point TP₁ by operating the robot 12 according to a position control command PC₁. When the tip 32a of the scraper 16 is arranged at the teaching point TP₁, as illustrated in FIG. 6, the tip 32a separates upward from the surface Q.

When the scraper 16 reaches the teaching point TP₁, the processor 40 starts a force control β. After starting the force control β, the processor 40 controls the position of the wrist flange 28b (or TCP) of the robot 12 based on the detection data of the force sensor 14 such that the pressing force F at which the robot 12 presses the scraper 16 against the surface Q of the workpiece W is controlled to a predetermined target value φ.

Specifically, in the force control β, the processor 40 generates a force control command FC for controlling the position of the wrist flange 28b (TCP) of the robot 12 in order to control the pressing force F (specifically, reaction force F′) acquired based on the detection data of the force sensor 14 to the target value φ. The processor 40 then adds the force control command FC to the position control command PCₙ to operate the servo motors 34 of the robot 12.

Accordingly, the processor 40 moves the scraper 16 (or the wrist flange 28b) in the direction MD of the movement path MP along the surface Q according to the position control command PCₙ, and moves the scraper 16 in the direction (i.e., the z-axis direction of the robot coordinate system C1) approaching to or leaving from the surface Q of the workpiece W according to the force control command FC.

The force control command FC includes a force command FC_{F} defining the target value φ and a speed command FC_{V} that specifies the speed at which the scraper 16 is moved in the z-axis direction of the robot coordinate system C1 in order to make the pressing force F reach the target value φ. In the force control β, the processor 40 first generates the force command FC_{F}, and then generates the speed command FC_{V} based on the pressing force F, which is acquired from the detection data of the force sensor 14, and the force command FC_{F}. The processor 40 then moves the scraper 16 (wrist flange 28b) in the z-axis direction of the robot coordinate system C1 by operating the robot 12 according to the speed command FC_{V}.

When the scraper 16 reaches the teaching point TP₁, the processor 40 generates a speed command PC_{V_2} as a position control command PC₂ to move the scraper 16 to the teaching point TP₂, and generates a speed command FC_{V_0} as the force control command FC. FIG. 6 schematically illustrates the speed commands PC_{V_2} and FC_{V_0} generated by the processor 40 when the scraper 16 reaches the teaching point TP₁.

After the scraper 16 has reached the teaching point TP₁, the processor 40 causes the robot 12 to operate in accordance with the speed command PC_{V_2} to move the scraper 16 toward the teaching point TP₂ and along the surface Q in the direction MD at a speed V_{P_2}. corresponding to (specifically, coinciding with) the speed command PC_{V_2}.

Along with this, the processor 40 generates the speed command FC_{V_0} to control the pressing force F to the target value φ, and by adding the generated speed command to the speed command PC_{V_2} to the servo motors 34, moves the scraper 16 in the direction toward the surface Q (i.e., downward) with a speed V_{F_0} corresponding to (specifically, coinciding with) the speed command FC_{V_0}. As a result, the robot 12 moves the scraper 16 in the direction MD′ in FIG. 6 after passing through the teaching point TP₁.

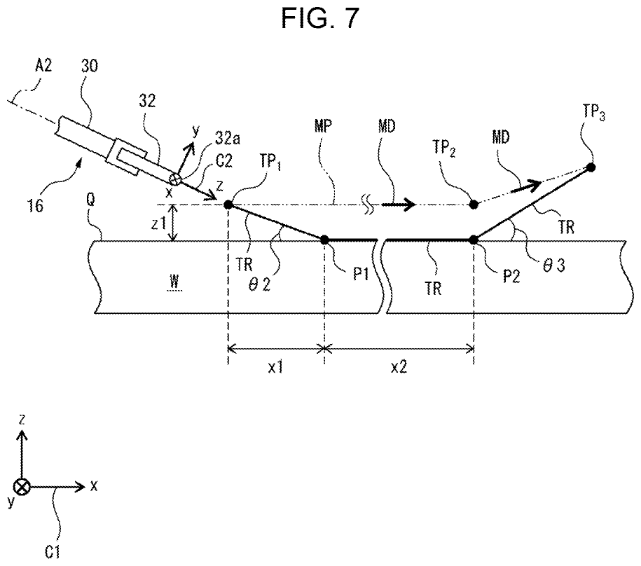

FIG. 7 illustrates with a solid line an actual trajectory TR that is followed by the scraper 16 (specifically, tip 32a) in the scraping process. After passing through the teaching point TP₁, the scraper 16 moves toward the surface Q in the trajectory TR inclined to form an angle θ2 (<90 degrees) with respect to the surface Q and abuts on the surface Q at a position P1.

Here, when the distances between the teaching point TP₁ and the position P1 in FIG. 7, in the x-axis and z-axis directions of the robot coordinate system C1, are a distance x1 and a distance z1, respectively, the distance x1 and the distance z1, the speed command PC_{V_2} (speed V_{P_2}), and the speed command FC_{V_0} (speed V_{F_0}) satisfy the following equation (1):

z1/x1=FC_{V_0}/PC_{V_2}=V_{F_0}/V_{P_2} (1)

Further, the angle θ2, the distance x1 and the distance z1, the speed command PC_{V_2} (speed V_{P_2}), and the speed command FC_{V_0} (speed V_{F_0}) satisfy the following equation (2):

θ2=tan⁻¹(z1/x1)=tan⁻(FC_{V_0}/PC_{V_2})=tan⁻(V_{F_0}/V_{P_2}) (2)

Thus, when assuming that a machining condition MC of the scraping process is set to x1=10 mm and z1=5 mm, it can be determined from the equation (2) that angle θ2≈26.6 degrees. In this case, when the speed V_{P_2} (i.e. speed command PC_{V_2}) is set to 100 mm/sec as the machining condition MC, the speed V_{F_0} (i.e., the speed command FC_{V_0}) can be determined as 50 mm/sec from equation (1). Thus, by appropriately setting the distance x1 and the distance z1, the speed command PC_{V_2} (the speed V_{P_2}), and the speed command FC_{V_0} (the speed V_{F_0}) as the machining condition MC, the angle θ2 can be controlled to a desired range (e.g., 15 degrees to 35 degrees).

While the scraper 16 is abutting against the surface Q, the processor 40 moves the scraper 16 in the direction MD (i.e., rightward) according to the position control command PC₂ and generates the speed command FC_{V_1} as the force control command FC for controlling the pressing force F to the target value φ by the force control β. In accordance with this speed command FC_{V_1}, the position of the wrist flange 28b of the robot 12 is shifted in the z-axis direction of the robot coordinate system C1 at a speed V_{F_1} corresponding to (specifically, coinciding with) the speed command FC_{V_1}.

Here, the maximum value of the speed command FC_{V_1} (i.e., the speed V_{F_1}) generated while the scraper 16 is abutting against the surface Q can be set to be larger than the speed command FC_{V_0} (i.e., the speed V_{F_0}) generated before the scraper 16 abuts against the surface Q. Thus, the processor 40, by the robot 12, moves the scraper 16 rightward along the surface Q while pressing the scraper 16 with the pressing force F of a magnitude corresponding to the target value φ, thereby executing the scraping process to scrape the surface Q by the tip 32a of the scraper 16.

When the scraper 16 (or the wrist flange 28b) reaches a position corresponding to the teaching point TP₂, the processor 40 terminates the force control β and generates a position control command PC₃ to move the scraper 16 to the teaching point TP₃. The processor 40 then moves the scraper 16 to upper right toward the teaching point TP₃ by operating the robot 12 according to the position control command PC₃.

As a result, the scraper 16 moves toward upper right in the trajectory TR inclined to form an angle θ3 (<90 degrees) with respect to the surface Q of the workpiece W, and the tip 32a of the scraper 16 separates away from the surface Q at a position P2. Thus, the scraper 16 scrapes the surface Q from the position P1 to the position P2 over a distance x2 and the scraping process ends. In the present embodiment, it is assumed that the coordinate of the position P2 in the x-axis direction of the robot coordinate system C1 is substantially identical to that of the teaching point TP₂. The scraper 16 then reaches the teaching point TP₃ (or a position just below it).

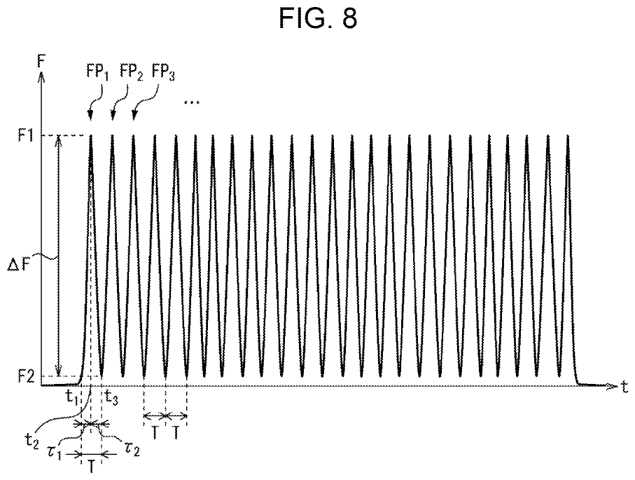

In the present embodiment, while executing the scraping process from the position P1 to the position P2, the processor 40 repeatedly controls the position of the wrist flange 28b of the robot 12 so as to repeatedly increase and decrease the pressing force F, thereby repeatedly increasing and decreasing a depth Z of scraping the surface Q. This function will be described below with reference to FIG. 8.

FIG. 8 illustrates an example of the time change characteristics of the pressing force F during execution of the scraping process. In the example illustrated in FIG. 8, the pressing force F, during the scraping process, changes repeatedly increasing and decreasing between a first force F1 and a second force F2 (>0) which is smaller than the first force F1. In the present embodiment, the processor 40 increases and decreases the pressing force F as illustrated in FIG. 8 by the force control β executed during the scraping process.

As an example of the force control β, the processor 40 generates the force command FC_{F} as the force control command FC as follows: That is, after the start of the force control β, the processor 40 generates a force command FC_{F} that specifies the initial target value φ₀ for the pressing force F, and operates the robot 12 according to the force command FC_{F}. With this, the scraper 16 abuts against the surface Q at the position P1 as illustrated in FIG. 7, and the pressing force F starts to increase and reaches the second force F2 at a time point t₁.

The processor 40 then generates a force command FC_{F} to increase the pressing force F by a change amount ΔF in a predetermined time period τ₁ from the time point t₁ and then decrease it by a change amount ΔF in a predetermined time period τ₂ thereafter. Note that the time period τ₁ and the time period τ₂ may be set to the same time period (τ₁=τ₂) or to different time periods (τ₁<τ₂, or τ₁>τ₂).

This increases the pressing force F to the first force F1 (=F2+ΔF) at the time point t2₂ (=t₁+τ₁), at which the time period τ₁ has elapsed from the time point t₁, and then decreases to the second force F2 at a time point t₂ (=t₂+τ₂). Thus, a first peak FP₁ waveform in the time change characteristics of the pressing force F illustrated in FIG. 8 is formed during the period from the time point t₁ to the time point t₃.

The processor 40 then generates a force command FC_{F} to repeat the cycle of increasing the pressing force F by a change amount ΔF for the time period τ₁ and then decreasing it by a change amount ΔF for the time period τ₂. By controlling the position of the wrist flange 28b of the robot 12 according to the force command FC_{F} thus generated, the pressing force F changes periodically such that the waveform of a peak FPₙ (n=1, 2, 3) of the pressing force F is formed in a cycle T (=τ₁+τ₂), as illustrated in FIG. 8.

Thus, in this case, the processor 40 is changing the target value φ of the pressing force F, in the force control β, between the first target value φ1 (=F1), which is increased by a change amount ΔF from the pressing force F at the time point t₁, and the second target value φ_{2_1} (=F2), which is decreased by a change amount ΔF from the pressing force F at the time point t₂. The initial target value φ₀ described above may be set to the force F1 or F2, or to any value of the force.

As another example of the force control β, the processor 40 may generate the force command FC_{F} as the force control command FC as follows: That is, after the start of the force control β, the processor 40 generates a force command FC_{F} to specify the first target value φ_{1_2} corresponding to the first force F1. By operating the robot 12 according to this force command FC_{F}, the scraper 16 abuts against the surface Q at the position P1 and the pressing force F reaches the second force F2 at the time point t₁ and then reaches the first force F1 at the time point t₂.

Then, at the time point t₂, the processor 40 generates a force command FC_{F} to specify the second target value φ_{2_2} (<φ_{1_2}) corresponding to the second force F2. By operating the robot 12 according to this force command FC_{F}, the pressing force F decreases from the time point t₂ to reach the second force F2 at the time point t₃. At this time point t₃, the processor 40 again specifies the first target value φ_{1_2} in the force command FC_{F}.

The processor 40, in the generated force command FC_{F}, then repeats the cycle of specifying the second target value φ_{2_2} after the time period τ₁ and specifying the first target value φ_{1_2} after the time period τ₂. Thus, in the force control β, the processor 40 periodically changes the target value φ of the pressing force F between the first target value φ_{1_2} and the second target value φ_{2_2}, which is smaller than the first target value φ_{1_2}. As a result, the pressing force F can be changed by the cycle T as illustrated in FIG. 8.

Note that the first target value φ_{1_2} used in this example may be the same value as the first force F1 (φ_{1_2}=F1) or may be larger than the first force F1 (φ_{1_2}>F1). When φ_{1_2}>F1, the pressing force F does not reach the first target value φ_{1_2} at the time point t₂ and the processor 40 generates a force command FC_{F} specifying the second target value φ_{2_2} before the pressing force F reaches the first target value φ_{1_2}.

In addition, the second target value φ_{2_2} may be the same value as the second force F2 (φ_{2_2}=F2) or smaller value than the second force F2 (φ_{2_2}<F2). When φ_{2_2}<F2, the pressing force F does not reach the second target value φ_{2_2} at the time point t₃ and the processor 40 generates a force command FC_{F} specifying the first target value φ_{1_2} before the pressing force F reaches the second target value φ_{2_2}.

As still another example of the force control β, the processor 40 may generate a force command FC_{F} such that the target value φ of the pressing force F changes over time with time change characteristics corresponding to the characteristics illustrated in FIG. 8. For example, the processor generates a force command FC_{F} such that the target value φ is gradually changed over time with a predetermined control cycle T′(<<T). Thus, the target value φ can be periodically changed between the first target value φ₁ and the second target value φ₂ such that the target value φ becomes time change characteristics corresponding to the characteristics illustrated in FIG. 8.

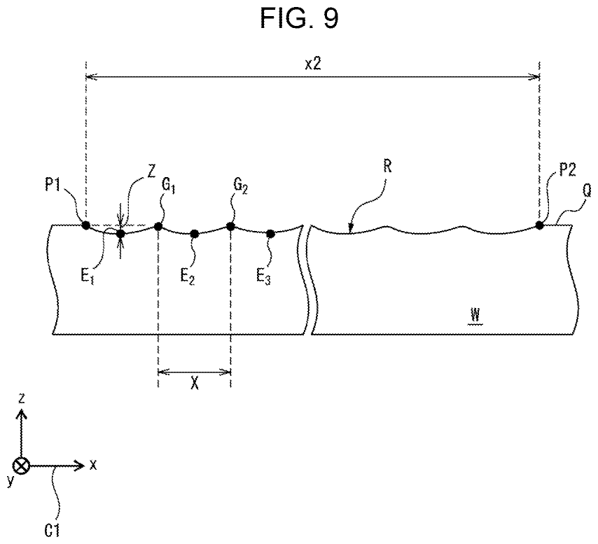

As described above, in the present embodiment, the processor 40 increases and decreases the pressing force F by repeatedly increasing and decreasing the target value φ of the pressing force F in the force control β. FIG. 9 illustrates an example of a recess R formed on the surface Q by the scraping process method according to the present embodiment. According to the present embodiment, periodically increasing and decreasing the pressing force F during execution of the scraping process (in other words, during pressing the scraper 16 against the surface Q and moving it in the direction MD), depth Z of scraping the surface Q periodically increases and decreases as illustrated in FIG. 9.

More specifically, the recess R extends rightward from the position P1 to the position P2, in which a plurality of valleys Eₙ (n=1, 2, 3) and a plurality of crest portions Gₙ are formed to be aligned in the x-axis direction of the robot coordinate system C1. The valley Eₙ corresponds to the position where the pressing force F becomes the first force F1 (first target value φ₁) in the characteristics illustrated in FIG. 8, and its depth Z in the recess R becomes maximum.

On the other hand, a crest portion Gₙ corresponds to the position where the pressing force F becomes the second force F2 (second target value φ₂) in the characteristics illustrated in FIG. 8, and its depth Z in the recess R becomes minimum. In the present embodiment, since the second force F2 is greater than zero, depth Z (i.e., the distance between the surface Q and the crest portion Gₙ in the z-axis direction of the robot coordinate system C1) of the crest portion Gₙ is greater than zero (i.e., the crest portion Gₙ is located below the surface Q). In FIG. 9, the depth Z of the recess R is illustrated enlarged for ease of understanding, but it should be understood that the depth Z is actually in the order of Ξm.

In the present embodiment, the recess R extending from the position P1 to the position P2 and including a plurality of valleys Eₙ and crest portions Gₙ therein can be formed by a single scraping process. Here, in the related art, when an expert of the scraping process forms a plurality of valleys Eₙ aligned in one direction by the scraping process as illustrated in FIG. 9, it is necessary to repeat the action of pushing the scraper against the surface Q with a strong force to scrape the surface Q and then moving the scraper away from the surface Q, in order to form one valley Eₙ. Such a task imposes heavy labor on an expert and requires a lot of time.

According to the present embodiment, the recess R as illustrated in FIG. 9, which has been formed by an expert repeatedly scraping the surface Q with a scraper, can be quickly formed by the operation of the robot 12. Thus, the cycle time of the scraping process can be reduced and the recess R can be automatically formed with the same quality as the recess formed by an expert.

Additionally, in the present embodiment, the processor 40 increases and decreases the pressing force F by executing the force control β while executing the scraping process, and repeatedly increasing or decreasing the target value φ in the force control β. Specifically, in the force control β, the processor 40 changes the target value φ between the first target value φ1 (φ_{1_1}, φ_{1_2}) and the second target value φ₂ (φ_{2_1}, φ_{2_2}). With this configuration, the pressing force F can be precisely controlled to change over time with the characteristics illustrated in FIG. 8. Thus, the depth Z of the recess R can be managed with high precision.

In addition, in the present embodiment, the processor 40 moves the scraper 16 in the direction MD while pressing it against the surface Q by executing the position control α with the force control β. With this configuration, the trajectory TR of the scraper 16 can be controlled with high precision. Also, in the present embodiment, the processor 40 increases and decreases the pressing force F periodically (specifically, with a cycle T). With this configuration, the recess R can be formed in which the valleys Eₙ are aligned by equal interval in the x-axis direction of the robot coordinate system C1.

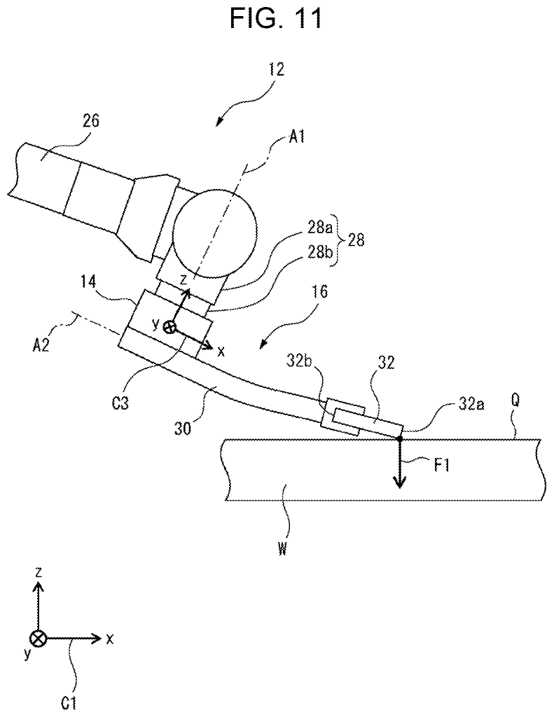

Note that the first target value φ1 (φ1_1, φ_{1_2}, ΔF) described above may be determined as the value by which the handle portion 30 can be bent when the blade portion 32 is pressed against the surface Q with the first force F1 during the scraping process. FIG. 11 schematically illustrates the bending state of the handle portion 30 during the scraping process. In the example illustrated in FIG. 11, the robot 12 presses the tip 32a of the scraper 16 against the surface Q with the first force F1, which causes the handle portion 30 of the scraper 16 to bend and curve to bulge downward. Note that the second target value φ₂ (φ_{2_1}, φ_{2_2}, ΔF) may be determined such that the handle portion 30 of the scraper 16 bends even when the scraper 16 is pressed against the surface Q by the second force F2.

Here, the memory 42 may store in advance a target value setting program PG1 for changing the target value φ as described above. In this case, after starting the force control β, the processor 40 determines the target value φ according to the target value setting program PG1 and generates a force command FC_{F} to specify the target value φ.

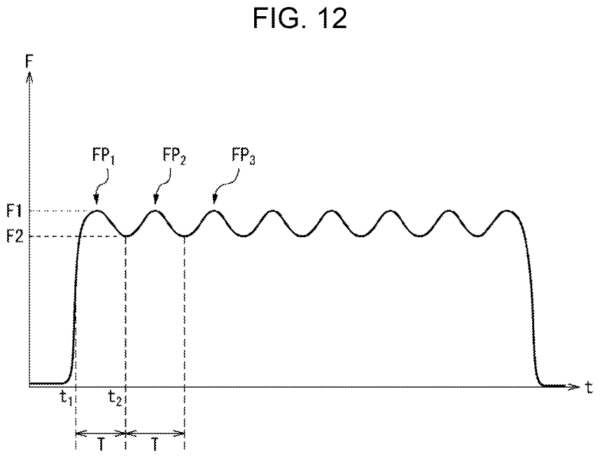

The mode of increasing and decreasing the pressing force F (target value φ) during the scraping process is not limited to the example illustrated in FIG. 8. Other modes of increasing and decreasing the pressing force F (target value φ) are described below with reference to FIGS. 12 to 15. In the example illustrated in FIG. 12, the processor 40 changes the pressing force F between the first force F1 and the second force F2 (<F1) with a cycle T.

Here, the second force F2 illustrated in FIG. 12 is set higher than the second force F2 illustrated in FIG. 8. According to the example illustrated in FIG. 12, the depth Z of the crest portion Gₙ of the formed recess R can be made relatively large. The processor 40 can control the pressing force F in a manner similar to the force control β described with reference to FIG. 8 such that the pressing force F has the time change characteristics illustrated in FIG. 12.

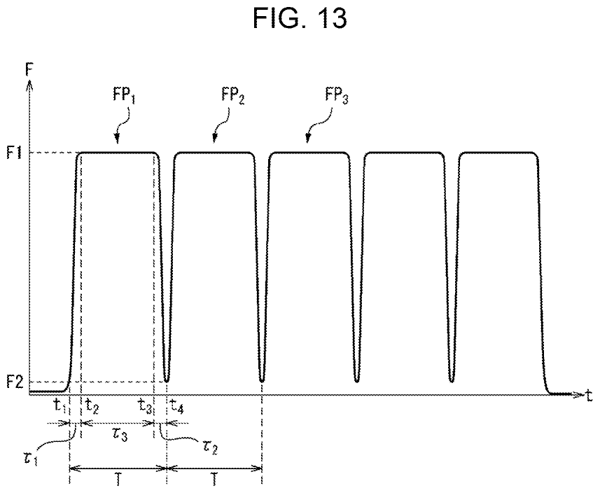

In the example illustrated in FIG. 13, during the scraping process, the pressing force F changes repeatedly increasing and decreasing between the first force F1 and the second force F2, but is maintained at the first force F1 for a predetermined time period τ₃. As an example of the force control β for increasing and decreasing the pressing force F as illustrated in FIG. 13, after the start of the force control β, the processor 40 generates a force command FC_{F} that specifies the initial target value φ₀ and operates the robot 12 according to the force command FC_{F}, as in the embodiments described above. This causes the pressing force F to reach the second force F2 at the time point t₁.

The processor 40 then generates a force command FC_{F} to increase the pressing force F from the time point t₁ by a change amount ΔF in the time period τ₁, maintain the pressing force F over a predetermined time period τ₃, and then decrease the pressing force F by a change amount ΔF in the time period τ₃. As a result, the pressing force F increases to the first force F1 from the time point t₁ to the time point t₂ (=t₁+τ₁), is maintained at the first force F1 from the time point t₂ to the time t₃ (=t₂+τ₃), and then decreases to the second force F2 from the time point t₃ to the time point t₄ (=t₃+τ₂). Thus, a waveform of the first peak FP₁ in the time change characteristics of the pressing force F illustrated in FIG. 13 is formed during the period from the time point t₁ to the time point t₄.

The processor 40 then generates a force command FC_{F} to repeat the cycle of increasing the pressing force F by a change amount ΔF in the time period τ₁, maintaining the pressing force F for the time period τ₃, and then decreasing the pressing force F by a change amount ΔF in the time period τ₂. By controlling the position of the robot 12 according to the force command FC_{F} thus generated, the pressing force F changes periodically between the first force F1 and the second force F2 such that the waveform of the peak FPₙ (n=1, 2, 3) of the pressing force F is formed by a cycle T (=τ₁+τ₂+τ₃) as illustrated in FIG. 13.

As another example of the force control β, after the start of the force control β, the processor 40 specifies the first target value φ_{1_2} corresponding to the first force F1 in the force command FC_{F} and operates the robot 12 according to the force command FC_{F}. This causes the pressing force F to reach the second force F2 at the time point t₁ and then reach the first force F1 at the time point t₂.

Then, in the force command FC_{F}, the processor 40 continuously specifies the first target value φ_{1_2} from the time point t₂ to the time point t₃ and specifies the second target value φ_{2_2} at the time point t₂. By operating the robot 12 in accordance with such a force command FC_{F}, the pressing force F is maintained in the first force F1 from the time point t₂ to the time point t₃ and then decreases from the time point t₃ to reach the second force F2 at the time point t₄.

At this time point t₄, the processor 40 again specifies the first target value φ_{1_2} in the force command FC_{F}. The processor 40 then repeats the cycle in the force command FC_{F} by specifying the second target value φ_{2_2} after the time period τ₁+τ₃ and specifying the first target value φ_{1_2} after the time period τ₂. As a result, the pressing force F can be changed by the cycle T between the first force F1 and the second force F2, as illustrated in FIG. 13.

As still another example of the force control β, in the force command FC_{F}, the processor 40 may gradually and temporally change the target value φ of the pressing force F with a control cycle T′(<<T) to correspond to the time change characteristics illustrated in FIG. 13. According to the force control β illustrated in FIG. 13, the recess R including the valley Eₙ extending linearly parallel to the x-axis of the robot coordinate system C1, can be formed.

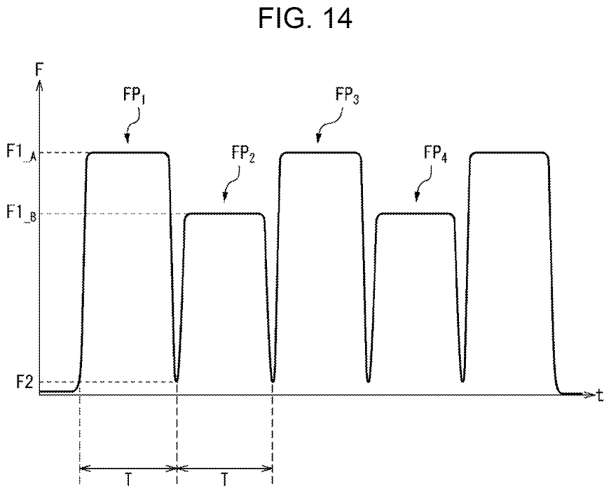

In the example illustrated in FIG. 14, the processor 40 changes the peak value of the first force F1 for each cycle T. Specifically, the processor 40 maintains the pressing force F at a force F1__{A} in the waveform of the 2 m−1-th peak FP_{2 m-1} (m is a positive integer) in FIG. 14, while maintaining the pressing force F at a force F_{1_B} (<F1__{A}) in the waveform of the 2m-th peak FP₂ₘ.

The method of the force control β illustrated in FIG. 14 differs from that in FIG. 13 in the following respects: That is, the processor 40 switches, for each cycle T, the first target value φ1 (φ1_1, φ_{1_2}) specified by the force command FC_{F} between the target value φ_{1_A} corresponding to the force F1__{A} and the target value φ_{1_B} (<φ_{1_A}) corresponding to the force F1__{B}.

In the example illustrated in FIG. 14, the recess R can be formed including a first valley Ell A extending linearly and a second valley E_{n_B} extending linearly with a depth shallower than that of the first valley E_{n_A}. Note that the processor 40 may generate a force command FC_{F} in a manner to maintain the pressing force F at the force F_{1_B} in the waveform of the 2 m−1-th peak FP_{2 m-1} in FIG. 14, while maintaining the pressing force F at the force F_{1_A} in the waveform of the 2m-th peak FP₂ₘ.

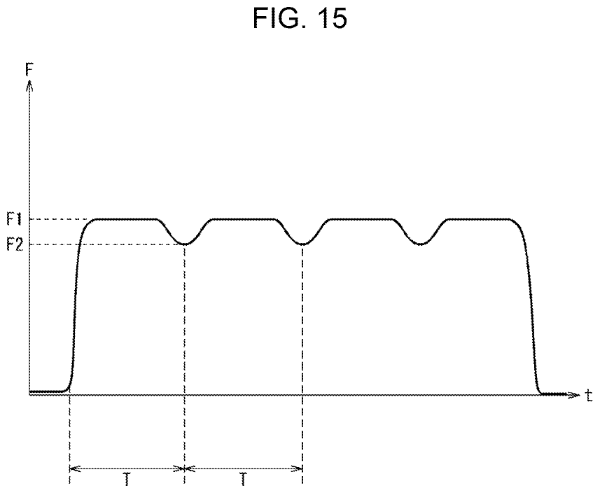

In the example illustrated in FIG. 15, the processor 40 maintains the pressing force F at the first force F1 for a predetermined period as in FIG. 13, but the second force F2 illustrated in FIG. 15 is set higher than the second force F2 illustrated in FIG. 13. According to the example illustrated in FIG. 15, the depth Z of the crest portion Gₙ of the formed recess R can be made relatively large. The processor 40 can control the pressing force F to have the time change characteristics illustrated in FIG. 15 by executing the force control β described with reference to FIG. 13.

The processor 40 may automatically determine at least one of the machining conditions MC according to the data input from the operator. For example, in addition to the angle θ2, distances x1 and z1, the speed command PC_{V_2} (the speed V_{P_2}), the speed command FC_{V_0} (speed V_{F_0}) illustrated in FIG. 7, the machining condition MC include at least one of the conditions including the length x2 of the recess R to be formed, a number k and the depth Z of the valley Eₙ (or crest portion Gₙ) to be formed in the recess R (FIG. 9), a distance X between two the crest portions Gₙ and Gₙ₊₁ (or two valleys Eₙ and Eₙ₊₁) adjacent to each other in the x-axis direction of the robot coordinate system C1 (FIG. 9), a cycle T to change the pressing force F, the target value φ of the force control β, and a gain Ga determining the control responsiveness of the robot 12.

As an example, the operator operates the input device 46 and inputs the speed command PC_{V_2} (the speed V_{P_2}), the length x2 of the recess R, the number k, and the depth Z, as the machining condition MC. In this case, the processor 40 automatically determines the distance X by calculating X=x2/k (or its approximate value) from the input lengths x2 and the number k.

Additionally, the processor 40 automatically determines the target value φ from the depth Z that is input. For example, the memory 42 may store in advance a data table DT1 in which the first target value φ₁ and the depth Z of the valley Eₙ (or the second target value φ₂ and the depth Z of the crest portion Gₙ) are stored in association with each other. In this case, the processor 40 can automatically determine the target value φ by retrieving the target value φ₁ (or φ₂) corresponding to the input depth Z from the data table DT1.

Furthermore, the processor 40 automatically determines, from the distance X (=x2/k) determined as described above and the speed command PC_{V_2} (the speed V_{P_2}) that is input, the cycle T as T=X/PC_{V_2} (=X/V_{P_2}). Here, whether the robot 12 can change the pressing force F with the determined cycle T (in other words, the wrist flange 28b is moved up and down for the cycle T) depends on the gain Ga. Specifically, the higher the gain Ga, the faster the control responsiveness of the robot 12, and the robot 12 can move the wrist flange 28b up and down at higher speeds.

When determining the cycle T, the processor 40 may automatically determine the gain Ga with which the robot 12 can operate at the cycle T. In this case, when a feasible gain Ga for achieving the determined cycle T cannot be set (For example, when the gain Ga goes beyond a range of configurable gain Ga), the processor 40 may issue an alarm signal reporting that.

As another example, the operator may input the gain Ga in place of the speed command PC_{V_2} (the speed V_{P_2}) described above as the machining condition MC. In this case, the processor 40 may automatically determine the cycle T from an input gain Ga. For example, the memory 42 may store in advance a data table DT2 in which the gain Ga and the cycle T are stored in association with each other.

In this case, the processor 40 can automatically determine the cycle T by retrieving the cycle T corresponding to the input gain Ga from the data table DT2. The data table DT2 may store the smallest cycle T_{MIN} feasible for the corresponding gain Ga as the cycle T. This cycle T_{MIN} can minimize the cycle time of the scraping process.

Then, the processor 40 automatically determines the speed command PC_{V_2} (the speed V_{P_2}) as PC_{V_2} (V_{P_2})=X T from the cycle T and the distance X determined as described above. As described above, the processor 40 can automatically determine other parameters of the machining conditions MC according to some parameters of the machining conditions MC input by the operator. This configuration simplifies the task of launching the robot system 10.

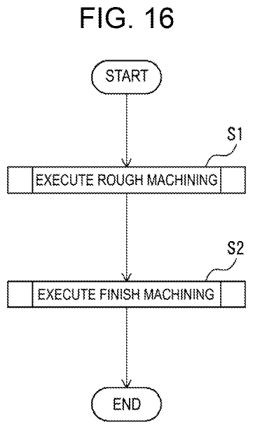

A scraping process method executed by the robot system 10 is now described with reference to FIGS. 16 to 18. The flow illustrated in FIG. 16 starts when the processor 40 receives a scraping process start command from the operator, the host controller or a work program PG2. In step S1, the processor 40 executes rough machining. Rough machining is, for example, a scraping process in order to reduce the fine unevenness, which is formed when the surface Q is machined with a milling machine or the like, to the first dimension (e.g., 10 μm) or less.

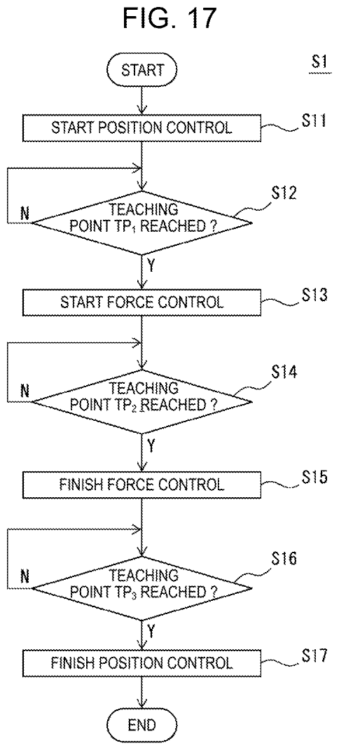

This step S1 will be described with reference to FIG. 17. In step S11, the processor 40 starts the position control α. Specifically, the processor 40 starts the operation of generating the position control command PCₙ described above, and starts the operation of moving the tip 32a of the scraper 16 by the robot 12 in the order of teaching point TP₁→TP₂→ and TP₃ (FIG. 7).

In step S12, the processor 40 determines whether the scraper 16 has reached the teaching point TP₁. For example, the servo motor 34 of the robot 12 is provided with a rotation detector (encoder or Hall element, or the like) that detects the rotation (specifically, rotation angles or rotational positions) of the servo motor 34.

The processor 40 acquires position data of the scraper 16 (specifically, TCP) in the robot coordinate system C1 based on feedback from the rotation detector, and can determine, from the position data, whether the scraper 16 has reached the teaching point TP₁. When determining that the scraper 16 has reached the teaching point TP₁ (i.e., YES), the processor 40 proceeds to the step S13, or when determining that the scraper 16 has not reached the teaching point TP₁ (i.e., NO), the processor 40 loops through the step S12.

In step S13, the processor 40 starts the first force control β1. Specifically, the processor 40 generates a force command FC_{F} specifying a target value φ₃ for the first force control β1. The processor 40 generates the speed command FC_{V_0} based on the force command FC_{F}, and operates the robot 12 by adding the speed command FC_{V_0} as the force control command FC to the speed command PC_{V_2} as the position control command PCₙ. As a result, the scraper 16 abuts on the surface Q at the position P1 with the trajectory TR (FIG. 7) inclined at the angle θ2.

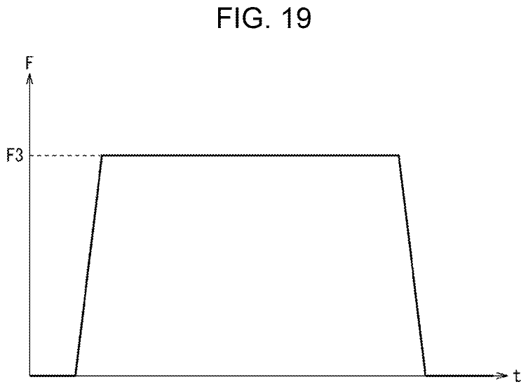

Here, the processor 40 maintains the pressing force F constant by the first force control β1 during execution of the scraping process from the position P1 to the position P2 in step S1 (rough machining). FIG. 19 illustrates the time change characteristics of the pressing force F in the first force control β1. As illustrated in FIG. 19, in the first force control β1, the processor 40 controls the position of the wrist flange 28b of the robot 12 to maintain the pressing force F at a predetermined target value φ₃ (=F3) without increasing or decreasing the pressing force F as illustrated in FIGS. 8 and 12 to 15.

In step S14, the processor 40 determines whether the scraper 16 (or wrist flange 28b) has reached the position corresponding to the teaching point TP₂. When determining YES, the processor 40 proceeds to step S15, or when determining NO, loops through step S14.

In step S15, the processor 40 terminates the first force control β1. After step S15, the processor moves the scraper 16 toward upper right along the trajectory TR inclined at angle θ3 as illustrated in FIG. 7 by operating the robot 12 in accordance with the position control command PC₃, and as a result, the scraper 16 separates away from the surface Q of a workpiece W1 at the position P2 and the rough machining is finished. By this rough machining, the flatness of the surface Q can be enhanced such that the fine unevenness on the surface Q is equal to or less than the first dimension.

In step S16, the processor 40 determines whether the scraper 16 has reached the teaching point TP₃. When determining YES, the processor 40 proceeds to step S17, or when determining NO, loops through step S16. Then, in step S17, the processor 40 terminates the position control α.

Referring again to FIG. 16, in step S2, the processor 40 executes finish machining. Finish machining is a scraping process to reduce the fine unevenness, which is formed on the surface Q after the rough machining, to less than the second dimension (e.g., 5 μm), which is smaller than the first dimension, and to form a recess to function as the oil retention described above.

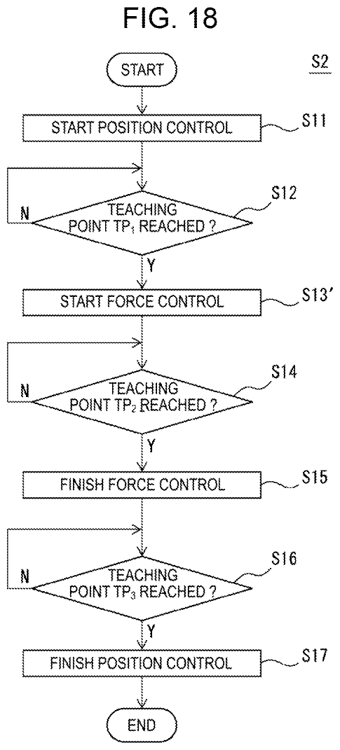

This step S2 will be described with reference to FIG. 18. The flow illustrated in FIG. 18 differs from the flow illustrated in FIG. 17 at step S13′. Specifically, after determining YES in step S12, the processor 40 starts the second force control β2 in step S13′. In this second force control β2, the processor 40 repeatedly increases and decreases the pressing force F by executing the force control β described above in FIGS. 8 and 12 to 15.

Thus, in the present embodiment, by executing step S2 (finish machining) after step S1 (rough machining) that increases the flatness of the surface Q to a certain extent by scraping the surface Q, the flatness of the surface Q can be further increased and the recess R, which functions as an oil retention, can be formed as illustrated in FIG. 9. This allows the robot system 10 to automatically execute rough machining and finish machining continuously.

In the flow illustrated in FIG. 16, step S2 may be executed first and then step S1 may be executed. In addition, the processor 40 may alternately execute steps S1 and S2 a plurality of times. The processor 40 executes the flow illustrated in FIG. 16 according to the target value setting program PG1 and the work program PG2, described above.

For example, the target value setting program PG1 is a computer program for which an algorithm for generating the target value φ is specified, while the work program PG2 is a computer program for which the position data of the teaching point TPₙ and the command statements for executing the position control α and the force control β are specified. These target value setting program PG1 and work program PG2 may be stored in the memory 42 as separate computer programs from each other, or may be integrated into one computer program and stored in the memory 42.

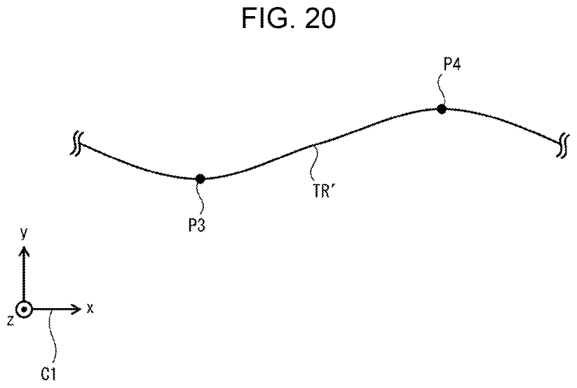

Note that in the embodiment described above, the processor 40 may execute an operation of swinging the scraper 16 (wrist flange 28b) in the y-axis direction of the robot coordinate system C1 during execution of the scraping process in synchronization with an operation of repeatedly increasing and decreasing the pressing force F. FIG. 20 illustrates an example of a trajectory TR′ of the scraper 16 when the scraper 16 is swung in this manner.

For example, the processor 40 may synchronize increasing and decreasing the pressing force F with the swing of the scraper 16 such that the pressing force F reaches the first force F1 in FIG. 8 when the scraper 16 reaches a swing peak point P3 at rear side and a swing peak point P4 at front side on the trajectory TR′ illustrated in FIG. 20, and the pressing force F reaches the second force F2 in FIG. 8 when the scraper 16 reaches the midpoint between the swing peak points P3 and P4. With this configuration, the recess R, which includes the valleys Eₙ aligned in staggered manner in the x-axis direction of the robot coordinate system C1, can be formed.

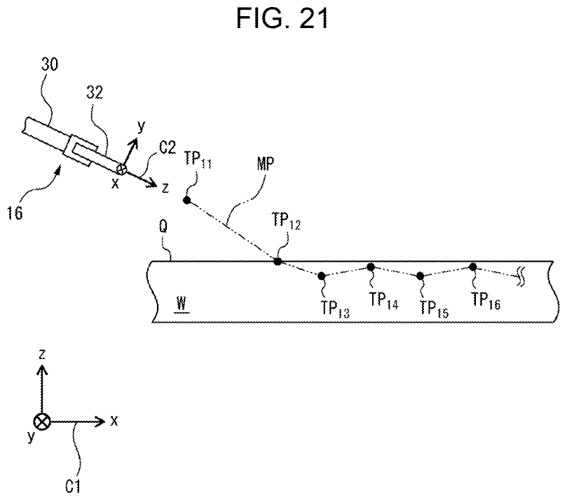

In the embodiment described above, the case where the processor 40 increases and decreases the pressing force F by executing the force control β, is described. However, without limiting to this, the processor 40 can also repeatedly increase and decrease the pressing force F by executing only the position control α. This function will be described with reference to FIG. 21.

In the configuration illustrated in FIG. 21, teaching points TP₁₁, TP₁₂, TP₁₃, TP₁₄, TP₁₅, TP₁₆ . . . are set along the surface Q of the workpiece W. Here, a teaching point TP₁₂ is arranged at the same position in the z-axis direction as the surface Q in the robot coordinate system C1, and the teaching points TP₁₃, TP₁₄, TP₁₅, TP₁₆ are arranged below the surface Q in the robot coordinate system C1. In addition, the teaching points TP₁₃ and TP₁₅ are located below the teaching points TP₁₄ and TP₁₆.

In the example illustrated in FIG. 21, the processor 40 executes the position control α to move the scraper 16 by the robot 12 in the order of teaching points TP₁₁→TP₁₂→TP₁₃→TP₁₄→TP₁₅→TP₁₆. Thus, the scraper 16 abuts against the surface Q at the teaching point TP₁₂. The processor 40 then moves the wrist flange 28b of the robot 12 to respective positions corresponding to the teaching points TP₁₃, TP₁₄, TP₁₅, and TP₁₆ in order, thereby moving the scraper 16 rightward along the surface Q while pressing it against the surface Q. Thus, the scraping process can be executed.

Here, by properly selecting the positions of the teaching points TPₙ (n=11, 12, 13 . . . ) illustrated in FIG. 21, the pressing force F can be controlled to have the time change characteristics illustrated in FIGS. 8 and 12 to 15 while the scraping process is executed. For example, the teaching point TPₙ is set appropriately such that the pressing force F reaches the first force F1 in FIG. 8 when the wrist flange 28b reaches respective positions corresponding to the teaching points TP₁₃ and TP₁₅, and the pressing force F reaches the second force F2 in FIG. 8 when the wrist flange 28b reaches respective positions corresponding to the teaching points TP₁₄ and TP₁₆.

In this case, the memory 42 may store in advance a data table DT3 in which the machining condition MC described above and the position data of the teaching points TPₙ (coordinates of the robot coordinate system C1) are stored in association with each other. The operator then operates the input device 46 and inputs at least one of, for example, the length x2, the depth Z, the distance X, and the target value φ as the machining condition MC. The processor 40 may automatically set the teaching points TPₙ as illustrated in FIG. 21 according to the machining condition MC that has been input.

Note that in the embodiment described above, the case of executing one scraping process on the surface Q of the workpiece W is described. However, the processor 40 may repeatedly execute the scraping process a plurality of times, for example, to form a plurality of recesses R aligned in the y-axis direction of the robot coordinate system C1. In this case, a group of teaching points TPₙ illustrated in FIG. 5 or FIG. 21 is set for each of the plurality of recesses R to be formed.

In addition, in FIGS. 8 and 12 to 15, the first force F1 or the second force F2 may change for each cycle T. For example, in the force control β illustrated in FIG. 8, a first force F L of the waveform of an i-th peak FPᵢ (i=1, 2, 3 . . . ) may be different from the first force F1ᵢ₊₁ of the waveform of the i+1-th peak FPᵢ₊₁.

Similarly, a second force F21 of the waveform of the i-th peak FPᵢ may be different from the second force F2ᵢ₊₁ of the waveform of i+1-th peak FPᵢ₊₁. In this case, the processor 40 changes the first target value φ₁ (or second target value φ₂) of the force control β to correspond to the first force F1ᵢ (or second force F2ᵢ) for each cycle T. The cycle T may also be changed for each peak FPᵢ. That is, a cycle τ₁ forming the i-th peak FPᵢ may have a different period from the cycle Tᵢ₊₁ forming the i+1-th peak FPᵢ₊₁.

The force controls β in FIGS. 8 and 12 to 15 can also be combined. For example, after the start of the force control β, the processor 40 may execute one of the force controls β in FIGS. 8 and 12 to for a predetermined period of time, and then execute another one of the force controls β in FIGS. 8 and. 12 to 15.

For example, the processor 40 may change the depth Z of the crest portion Gₙ by executing the force control β illustrated in FIG. 12 after executing the force control β illustrated in FIG. 8. Alternatively, the processor 40 may change the depth Z of the valley Eₙ and the crest portion Gₙ by executing the force control β illustrated in FIG. 14 or FIG. 15 after executing the force control β illustrated in FIG. 13. With this configuration, recess R of various shapes can be formed.

In the embodiment described above, as illustrated in FIG. 7, a case, where the tip 32a of the scraper 16 reaches the teaching point TP₃ at the end of the scraping process, and the x coordinate of the position P2 and the teaching point TP₂ in the robot coordinate system C1 are substantially identical, is described. However, it should be understood that in practice, at the end of the scraping process, the tip 32a of the scraper 16 may deviate from the teaching point TP₃ (e.g., downward) and the position P2 may deviate from the teaching point TP₂ (e.g., to the x-axis plus direction of the robot coordinate system C1).

Furthermore, the force sensor 14 may be interposed, for example, between the work cell and the robot base 20, or may be provided at any part of the robot 12. The force sensor 14 may be provided, not only at the robot 12, but also at the workpiece W side. For example, the pressing force F can be detected by interposing the force sensor 14 between the workpiece W and a placement surface on which the workpiece W is placed.

The force sensor 14 is not limited to a six-axis force sensor, and may be, for example, a single-axis or a three-axis force sensor, or may be any sensor capable of detecting the pressing force F. In addition, the origin of the sensor coordinate system C3 may be arranged, not only at the center of the force sensor 14, but also at any position as long as the position is previously known with respect to the force sensor 14, and the axes of the sensor coordinate system C3 may be defined in any directions.

The robot 12 is not limited to a vertical articulated robot, and may be any type of robot, for example, a horizontal articulated robot, a parallel link robot, or may be a movement machine including a plurality of ball screw mechanisms. Although the present disclosure has been described above through the embodiments, the above embodiments are not intended to limit the invention as set forth in the claims.

### REFERENCE SIGNS LIST

10: Robot system
12: Robot
14: Force sensor
16: Scraper
18: Control device
40: Processor

1. A robot system configured to perform a scraping process to scrape and flatten a surface of a workpiece, the robot system comprising:
a robot configured to move a scraper configured to scrape the surface; and
a control device configured to control the robot, wherein
the control device is configured to:
execute the scraping process by moving the scraper in a direction along the surface while pressing the scraper against the surface by the robot; and
during the execution of the scraping process, repeatedly increase and decrease a depth of scraping the surface by controlling a position of the robot so as to repeatedly increase and decrease a pressing force by which the robot presses the scraper against the surface.

2. The robot system of claim 1, further comprising a force sensor configured to detect the pressing force, wherein
the control device is configured to:
during the execution of the scraping process, control the position of the robot by executing a force control for controlling the pressing force to a predetermined target value based on detection data of the force sensor; and
increase and decrease the pressing force by repeatedly increasing and decreasing the target value in the force control.

3. The robot system of claim 2, wherein the control device changes the target value between a first target value and a second target value smaller than the first target value in the force control.

4. The robot system of claim 3, wherein the scraper includes:
a flexible handle portion connected to the robot; and
a blade portion fixed to a tip of the handle portion and configured to scrape the surface, wherein
the first target value is determined as a value by which the handle portion can be bended when the blade portion is pressed against the surface by the pressing force corresponding to the first target value.

5. The robot system of claim 2, wherein the control device is configured to move the scraper in the direction along the surface in the scraping process by executing position control for moving the scraper to a plurality of teaching points sequentially, together with the force control, the plurality of teaching points being predetermined along the surface.

6. The robot system of claim 1, wherein the control device periodically increases and decreases the pressing force.

7. A method of a scraping process to scrape and flatten a surface of a workpiece, using a robot configured to move a scraper configured to scrape the surface, the method comprising:
executing the scraping process by moving the scraper in a direction along the surface while pressing the scraper against the surface by the robot; and
during the execution of the scraping process, repeatedly increasing and decreasing a depth of scraping the surface by controlling a position of the robot so as to repeatedly increase and decrease a pressing force by which the robot presses the scraper against the surface.

8. A computer-readable storage medium configured to store a computer program that causes a processor to execute the method of claim 7.
